(19) United States
(12) Patent Application Publication
(10) Pub. No.: US 2004/0024627 A1
(43) Pub. Date: Feb. 5, 2004

(54) Method and system for delivery of infrastructure components as they related to business processes

(76) Inventor: Mark Bradford Keener, Katy, TX (US)

Correspondence Address: Mark Bradford Keener, 22619 Bucktrout Ln., Katy, TX, 77449, US

(21) Appl. No.: 10/625,878

(22) Filed: Jul. 24, 2003

Related U.S. Application Data
(60) Provisional application No. 60/399,795, filed on Jul. 31, 2002.

(51) Int. Cl. G06F 17/60

(52) U.S. Cl. 705/7

(57) ABSTRACT

Business Technology Relationship Model (BTRM) is a method for abstracting and modeling the relationships that exist between technical infrastructure components and specific business processes, resulting in a proprietary Business Technology Relationship Protocol. The method defines a dependency approach to technical infrastructure delivery and management by creating the 13 Layer BTRM Dependency/Impact Hierarchy, a modeled understanding of the dependencies that specific business processes have on specific technical infrastructure components, including the interdependencies between modeled business and technical objects. When the resulting Relationship Protocol is placed into software, the BTRM Method improves the delivery and management of technology infrastructure and technology support services spanning a diverse set of industries and business disciplines.

### CROSS REFERENCE TO RELATED APPLICATIONS

Not Applicable

### STATEMENT REGARDING FEDERALLY SPONSORED RESEARCH OR DEVELOPMENT

Not Applicable

### BACKGROUND

1. Field of the Invention

This invention relates to a method, and more particularly, to a system for the delivery and management of technical infrastructure components as they financially and operationally relate to a specific business process.

2. Related Art

Before the introduction of Information Technology (IT) into the business process, a company's strategic goals and objectives were realized solely through business management techniques. Business management was based, in part, on understanding and controlling every aspect of the business process. With the introduction of technology, IT professionals, whose knowledge of the business process was limited, gained influence over many tightly controlled tasks, which were once completely within the jurisdiction of business process owners. Much of the control over the business process shifted away from business process owners into the hands of IT. These same IT professionals, however talented and capable of designing and implementing business systems and infrastructure, often lacked a necessary understanding of company strategies and business process critical success factors. This evolution has obviously placed significant dependence on the IT Organization, and has placed a significant value on effective IT infrastructure management techniques.

The larger and more complex a company's technical infrastructure becomes the more difficult it becomes to analyze and control costs, implement effective and efficient processes, and deliver value relative to the business strategy which technical infrastructure exists to support. The ability to determine how any single part of the technical infrastructure contributes to strategic business goals and objectives is often not possible. These limitations impact technology service and support organizations and their ability to deliver cost effective services, and the core business' ability to fully achieve strategic goals and objectives.

### SUMMARY OF THE INVENTION

The preferred embodiment of the present invention is a fundamentally unique and proprietary methodology that creates a 13 Layer Dependency/Impact Hierarchical Model representing individual technical infrastructure components as they relate to individual business processes. The Business Technology Relationship Model (BTRM) Dependency/Impact Hierarchy considers every technical infrastructure component necessary to support any specific business activity, regardless of the variations or type of technology. The resulting hierarchy describes the inter-dependencies between various technical infrastructure components, and their potential operational and financial impact on specific business processes and business units.

The BTRM Dependency/Impact Hierarchy provides a strategic view of how individual technical infrastructure components and services are delivered. For example, narrowing the focus of Information Technology (IT) support activities to the exact technical infrastructure dependencies of a single business process allows IT to align their efforts with those of the process, thus reducing the costs of technology services, and becoming a direct participant in business process's performance and critical success factors. The BTRM Dependency/Impact Hierarchy places technical infrastructure issues and support decisions in a strategic business context, driving technical infrastructure management from a strategic business perspective. The value of services and technical infrastructure components become obvious relative to the value of the core business they support.

### BRIEF DESCRIPTION OF THE DRAWINGS

FIG. 1 is a block diagram of the Business Technology Relationship Model (BTRM) static layers that are the framework for the BTRM Dependency/Impact Hierarchy.

FIG. 2 is a block diagram representing the recursive process for identification of dependent objects in the BTRM Dependency/Impact Hierarchy.

FIG. 3 is a block diagram representing the resulting identification of impact to dependent objects in the BTRM Dependency/Impact Hierarchy.

FIG. 4 is a block diagram representing the process and method for creating the BTRM Dependency/Impact Hierarchy.

FIG. 5 is a block diagram of the file abstracts that occur within the BTRM Dependency/Impact Hierarchy Application Objects Layer.

### DETAILED DESCRIPTION OF THE DRAWINGS

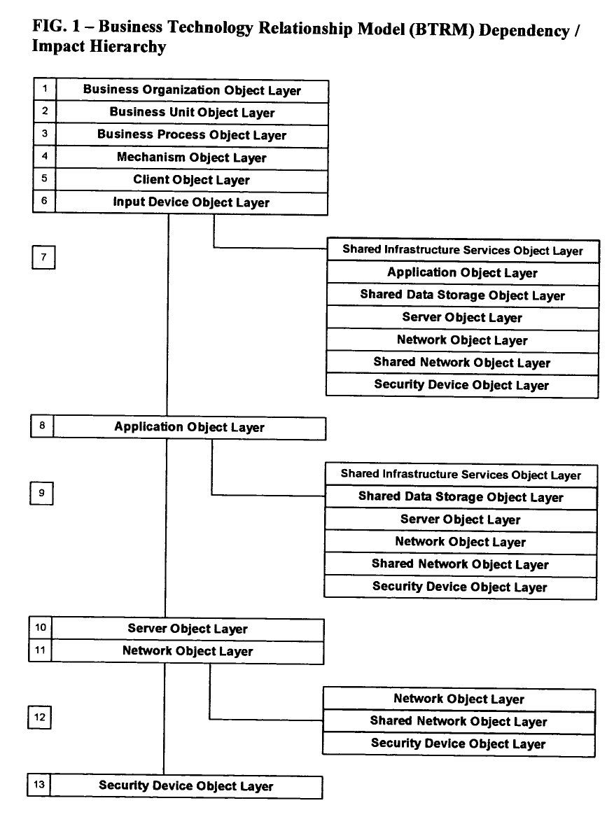

FIG. 1 is a block diagram of the 13 static layers of the Business Technology Relationship Model (BTRM). This framework supports the creation of the BTRM Dependency/Impact Hierarchy, which represents the relationships a specific technical infrastructure component(s), has to an individual business process(s). The drawing illustrates the Primary Model Layers (layers 1 through 6, and layers 8, 10, 11, and 13) and the Bridged Common Object Layers (layers 7, 9, and 12). As seen in FIG. 1, a Bridged Common Object Layer will contain a discreet BTRM Dependency/Impact Hierarchy within the Layer.

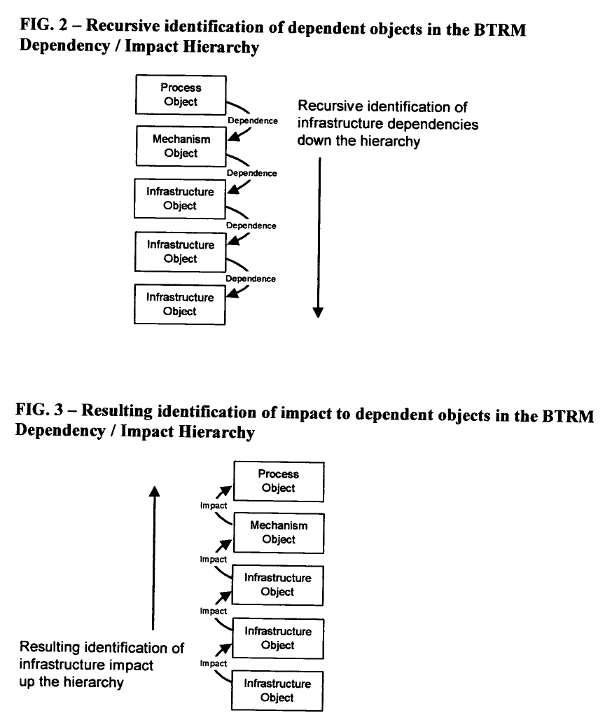

FIG. 2 is a block diagram representing the recursive process for the identification of dependent objects in the BTRM Dependency/Impact Hierarchy. The recursive process defines dependencies based on the Business Technology Relationship Model.

FIG. 3 is a block diagram representing the resulting identification of impact to dependent objects in the BTRM Dependency/Impact Hierarchy. Dependencies created using the BTRM Method, result in impact analysis. This impact analysis may be applied in numerous technology service delivery scenarios.

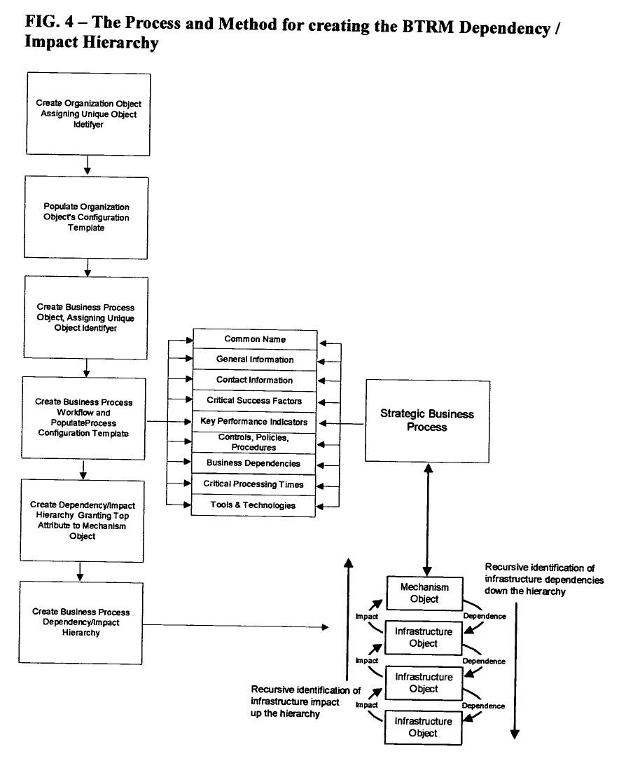

FIG. 4 is a block diagram representing the process and methodology for creating the BTRM Dependency/Impact Hierarchy beginning with an understanding and abstraction of business process layers, workflows, controls, performance indicators, etc. Once the business process layers have been abstracted, the recursive identification of technical infrastructure component dependencies creates a view of how specific technical infrastructure components have an operational and financial impact on the specific modeled business process.

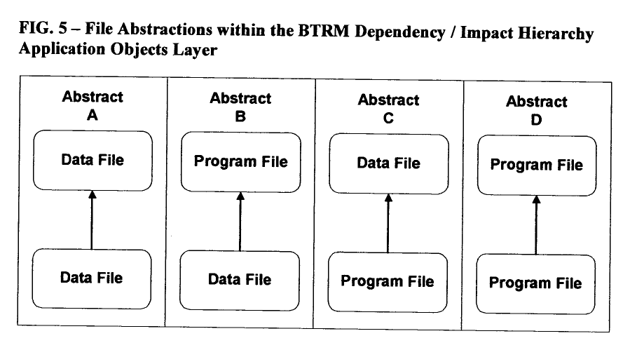

FIG. 5 is a block diagram of the file abstracts that occur within the BTRM Dependency/Impact Hierarchy Application Objects Layer. There are four possible Abstracts for Program and Data files as shown in FIG. 5. Each described as:

Abstract A is a Data file modeled above another Data file. This Abstract would be used when one Data file receives data from another Data file. The Data file receiving the data is indicating a dependency from which the data originates.

Abstract B is a Program file modeled above a Data file. This Abstract is used when a Program file reads, writes, edits, or deletes, data in a Data file. In Abstract B, the Program file has a dependency on the Data file. In Abstract B

Abstract C is a Data file dependent upon a Program file. This Abstract illustrates when a Program file reads, writes, edits, or deletes a Data file. In Abstract C the data file has a dependency on the Program file.

Abstract D shows a Program file dependent upon another Program file. This Abstract is used when one Program file calls or launches another Program file. In Abstract D the uppermost Program file has a dependency on the lower Program file.

### DETAILED DESCRIPTION OF THE INVENTION

Detailed Description of Preferred Embodiments

The method for creating the Business Technology Relationship Model (BTRM) Dependency/Impact Hierarchy forms the basis for business/technology alignment as seen in FIG. 4. When the method is placed in software, the BTRM Dependency/Impact Hierarchy is focused on aligning a specific technical infrastructure component, product, service deliverable, or management technique with a strategic business process, business unit, department, or business performance indicator. The method facilitates the population of BTRM Dependency/impact Hierarchies, and allows for traversal down (dependency) and up (impact) of the hierarchies. (FIGS. 2 and 3)

Once a BTRM Dependency Hierarchy has been created for a specific business process, and a Mechanism Object populates the top abstracted infrastructure object spot (most dependent), all other technical infrastructure objects placed in the hierarchy are done so traversing down the hierarchy, capturing all technical infrastructure object dependencies. Dependant technical infrastructure objects continue to be recursively captured down the Dependency Hierarchy until the bottom-most (least dependent) technical infrastructure component is defined, and no further dependencies can be named as shown in FIG. 2.

Once a Dependency Hierarchy is complete, a bottom-up Impact Hierarchy is determined by reversing the order in which dependency was defined, traversing up the Impact Hierarchy from the bottom-most (most impact-full) object as shown in FIG. 3.

### PARTICULAR IMPLEMENTATIONS OF THE INVENTION

The Business Technology Relationship Model (BTRM) Method may be implemented manually, but more particularly, in software. While various implementations of the present invention are described below, it should be understood that they are presented by way of example only, and not limitation. Therefore, the breadth and scope of the present invention should not be limited by any of the below described implementations, but should be defined only in accordance with the claims and their equivalents.

Outsourcing Management

The BTRM Method supports technical infrastructure outsourcing decisions from a strategic business context, identifying those technical infrastructure components that contribute to strategic business initiatives and those that do not. Based on strategic business goals and objectives, the BTRM Method identifies technical infrastructure that business owners want to maintain control over, and technical infrastructure components that are candidates for outsourcing.

Merger & Acquisition Management

The BTRM Method illustrates key business processes and the exact technical infrastructure components that support each of them. BTRM will identify which systems to keep, what data is important and how much integration is actually needed before companies are technically joined.

Business Process Improvements

The BTRM Method presents information about the relationship between business processes and the exact technical infrastructure they are dependent upon. Understanding the impact that discreet technical infrastructure has on specific business processes is critical to the business process improvement effort. The BTRM Method provides business owners and service providers a way to gain full engagement by Information Technology professionals in the business process improvement effort.

Systems Integration

The BTRM Method provides a tool to define ‘as is’ and ‘to be’ models of the exact technical infrastructure integration effort, reducing time needed for analysis, decision, and implementation.

Service Delivery and Process

The BTRM Method places technical infrastructure support processes and management in a strategic business context, providing the proper context when defining technical infrastructure support priorities. BTRM Dependency/Impact Hierarchies illustrate the exact delivery of technology linked to strategic business initiatives, and that which is not.

EDP Auditing

The BTRM Method produces a narrow view of the precise relationships between discreet technical infrastructure components and the specific business process they support. This Method provides focus to the EDP audit, that otherwise views technical infrastructure as a loose affiliation of systems, networks, applications, and business processes.

Disaster Recovery & Business Continuity Planning

The BTRM Method reduces the scope of the Disaster Recovery & Business Continuity, focusing the recovery effort to only those exact technical infrastructure components necessary to support business process recovery targets, and eliminates those that don't. This Method reduces initial and on-going costs associated with Disaster Recovery & Business Continuity Planning.

Risk & Security Management

The BTRM Method supports Risk and Security Management by illustrating the operational relationships that exist between any specific business entity and the specific corporate data, technical infrastructure, and technical delivery of service that they are dependent on.

Business Impact Analysis

The viewing of BTRM Dependency/Impact Hierarchies automates the visualization of operational and financial impact specific technical services and infrastructure components have on specific business processes. This automation greatly reduces the time needed for analysis, decision, and implementation.

Knowledge Management

For business process owners, the BTRM Method unravels the complexities of technical infrastructure providing detailed information on the exact technical infrastructure components that support their process(s). BTRM Dependency/Impact Hierarchies contribute to new employees becoming productive more quickly, reducing the cost of training new employees, and securing strategic corporate knowledge when key employees leave.

Integration of Information Technology Service Management

The BTRM Method removes the silo'ed approach to the management and delivery of technology services, placing all Service Management disciplines in the same delivery context. The following managed services can be delivered from a common repository of BTRM Dependency/Impact Hierarchies.

IT Change Management

The BTRM Method creates a direct relationship between specific technical infrastructure components and strategic business processes. The Dependency/Impact Hierarchy identifies all business processes dependent on any individual technical infrastructure component. When placed in software, the BTRM Relationship Protocol automates the visualization of potential upstream, downstream, and in-stream business process impact. BTRM greatly reduces the time required to determine business impact from each proposed technical infrastructure component change.

Service Level Management

The BTRM Method compels specific and discreet technical infrastructure service level metrics into alignment with a specific business entity. The BTRM Method narrows the scope of Service Level Management, to only those technical infrastructure components and services that contribute to business process availability and performance.

Problem Management

The BTRM Method illustrates the exact business entity that is impacted by a technical infrastructure component failure or event. BTRM supports delivering Problem Management by enabling the prioritization of problem resolution efforts, based on the priority of the business process impacted.

Event and Fault Management

Applying the BTRM Dependency/Impact Hierarchy to Event and Fault Management provides state propagation from an individual technical infrastructure component event, to business process impact. Metrics generated on technical infrastructure objects in the Dependency/Impact Hierarchy have absolute value relative to the business process(s) they support. The BTRM Method facilitates the creation of rules relative to state propagation and root cause analysis of technical infrastructure events, correlating technical infrastructure events with business process impact. This results in a visual representation of the relationship between Event and Fault Management metrics and Business Impact Analysis, illustrating business process performance, availability, Critical Success Factors, Key Performance Indicators, Business and Regulatory Controls, Policies, and Procedures.

Asset and Inventory Management

The BTRM Method determines exact technical infrastructure cost metrics per business entity, determines the ongoing costs of legacy systems relative to the value of the business they support, identifies costs metrics associated with maintaining past investments, and identifies infrastructure components that no longer contribute to strategic goals.

IT Impact Analysis

The BTRM Dependency/Impact Hierarchy defines the absolute relationships that technical infrastructure components have to one another, graphically representing their interdependencies, improving the decision, analysis, and implementation process.

Root Cause Analysis

The BTRM Method supports the automation and correlation of events impacting multiple business processes. The automation of Root Cause Analysis is supported by the identification of specific technical infrastructure objects that are common across impacted business processes, and the lowest impacted object in the BTRM Dependency/Impact Hierarchy.

Life Cycle Management

The BTRM Method provides a view of the ongoing operational and financial impact of specific technical infrastructure components or groups of technical infrastructure components as they relate to the value of the specific business process they support.

What I claim as my invention is:

1. A method and system for creating a relationship model and dependency hierarchy for delivery and management of technology components as they relate to, and impact, specific business processes.

2. A method as in claim 1, further including:
(a) The Business Technology Relationship Model (BTRM) consists of 13 layers.
(b) The vertical placement of the BTRM layers is constant and static.
(c) The relationship between BTRM layers is constant and static.
(d) The BTRM represents a series of dependencies, with each layer dependent on the layer below it.
(e) BTRM layers 1 through 3 are reserved for business abstraction.
(f) BTRM layers 4 through 13 are reserved for technical infrastructure abstraction.

3. A method as in claim 2, wherein there are 13 Layers on the BTRM and they include:
(a) Business Organization Object Layer 1
(b) Business Unit Object Layer 2
(c) Business Process Object Layer 3
(d) Mechanism Object Layer 4
(e) Client Object Layer 5
(f) Input Device Object Layer 6
(g) Shared Infrastructure Services Object Layer 7
(h) Application Object Layer 8
(i) Shared Data Storage Object Layer 9
j) Server Object Layer 10
(k) Network Object Layer 11
(l) Shared Network Infrastructure Object Layer 12
(m) Security Device Object Layer 13

4. A method as in claim 2, further including:
(a) BTRM is the framework for the BTRM Dependency/Impact Hierarchy.
(b) The BTRM Dependency/Impact Hierarchy represents the recursive identification and documentation of technical infrastructure objects traversing down the BTRM as they relate to a specific business process.
(c) Modeling of all dependencies between layers on the BTRM Dependency/Impact Hierarchy is done vertically, and no horizontal dependencies exist in the BTRM Dependency/Impact Hierarchy.
(d) On the BTRM Dependency/Impact Hierarchy, Business layers are modeled above technology infrastructure layers.

5. A method as in claims 2 or 4, in which a Bridged Common Object Layer contains a subset of BTRM layers, including a discreet Dependency/Impact Hierarchy within the Bridged Common Object Layer.

6. A method as in claim 5 further including:
(a) Layer 7 of the BTRM, Shared Infrastructure Services Object Layer, is a Bridged Common Object Layer containing a discreet Dependency/Impact Hierarchy subset of BTRM Model Layers 8 through 13.
(b) Layer 9 of the BTRM, Shared Data Storage Object Layer, is a Bridged Common Object Layer containing a discreet Dependency/Impact Hierarchy subset of BTRM Model Layers 7 through 13.
(c) Layer 12 of the BTRM, Shared Network Object Layer, is a Bridged Common Object Layer containing a discreet Dependency/Impact Hierarchy subset of BTRM Model Layers 11 through 13.

7. A method as in claim 4, further including:
(a) Objects within the BTRM Dependency/Impact Hierarchy represent individual business or technical infrastructure components or groups of business or technical infrastructure components.
(b) The placement of objects on the BTRM Dependency/Impact Hierarchy is constant and static.
(c) The relationship between objects on the BTRM Dependency/Impact Hierarchy is constant and static.
(d) Infrastructure objects modeled at the top of a BTRM Dependency/Impact Hierarchy are dependent on those objects modeled below.
(e) On the BTRM Dependency/Impact Hierarchy, Business objects are modeled above technology infrastructure objects.
(f) There is no limit to the number of objects on the BTRM Dependency/Impact Hierarchy.
(g) There is no limit to the number of objects within a specific layer on the BTRM Dependency/Impact Hierarchy.
(h) The placement of objects on the BTRM Dependency/Impact Hierarchy persistently reflects dependency, and may or may not reflect data flow.

8. A method as in claim 7, in which a Business Organization Object represents an individual business organization object or group of business organization objects.

9. A method as in claim 8, further including:
(a) On the BTRM Dependency/Impact Hierarchy, the Business Organization Object is the upper-most business object of the abstracted business layers 1 through 3.
(b) All other business objects are modeled below a Business Organization Object.
(c) On the BTRM Dependency/Impact Hierarchy, a Business Organization Object is modeled above a Business Unit Object.
(d) On the BTRM Dependency/Impact Hierarchy, a Business Organization Object is dependent upon a Business Unit Object.

10. A method as in claim 7, in which a Business Unit Object reflects an individual business unit object or group of business unit objects.

11. A method as in claim 10, further including:
(a) On the BTRM Dependency/Impact Hierarchy, a Business Unit Object is modeled below a Business Organization Object.
(b) On the BTRM Dependency/Impact Hierarchy, a Business Unit Object is modeled above a Business Process Object.
(c) On the BTRM Dependency/Impact Hierarchy, a Business Unit Object is dependent upon a Business Process Object.

12. A method as in claim 7, in which a Business Process Object reflects an individual business process object or group of business process objects.

13. A method as in claim 12, further including:
(a) On the BTRM Dependency/Impact Hierarchy, a Business Process Object is modeled below a Business Unit Object.
(b) On the BTRM Dependency/Impact Hierarchy, a Business Process Object is modeled above a Mechanism Object.
(c) On the BTRM Dependency/Impact Hierarchy, a Business Process Object is dependent upon a Mechanism Object.

14. A method as in claim 7, in which a Mechanism Object represents an individual tool or a technology that supports a specific business process.

15. A method as in claim 14, further including:
(a) On the BTRM Dependency/Impact Hierarchy, the Mechanism Object is the upper-most technical object of the abstracted technical infrastructure layers 4 through 13.
(b) All other technical infrastructure objects are modeled below the Mechanism Object Layer.
(c) On the BTRM Dependency/Impact Hierarchy, the Mechanism Object is modeled below the Business Process Object.
(d) On the BTRM Dependency/Impact Hierarchy, the Mechanism Object is modeled above the Client Object.
(e) On the BTRM Dependency/Impact Hierarchy, the Mechanism Object is dependent upon the Client Object.

16. A method as in claim 7, in which the Client Object represents an application user interface executing at a user input device.

17. A method as in claim 16, further including:
(a) On the BTRM Dependency/Impact Hierarchy, the Client Object is modeled below the Mechanism Object.
(b) On the BTRM Dependency/Impact Hierarchy, the Client Object is modeled above the Input Device Object.
(c) On the BTRM Dependency/Impact Hierarchy, the Client Object is dependent upon the Input Device Object.

18. A method as in claim 7, in which the Input Device Object represents an individual physical device used for the input, viewing, or manipulation of data and programs by a user.

19. A method as in claim 18, further including:
(a) On the BTRM Dependency/Impact Hierarchy, the Input Device Object is modeled below the Client Object.
(b) On the BTRM Dependency/Impact Hierarchy, the Input Device Object is modeled above the Application Object.
(c) On the BTRM Dependency/Impact Hierarchy, the Input Device Object is dependent upon the Application Object.
(d) When the BTRM Dependency/Impact Hierarchy includes the abstraction of the Shared Infrastructure Services Object Layer, the Input Device Object is also modeled above the Shared Infrastructure Services Object.
(e) When the BTRM Dependency/Impact Hierarchy includes the abstraction of the Shared Infrastructure Services Object Layer, the Input Device Object is also dependent upon the Shared Infrastructure Services Object.

20. A method as in claim 7, in which the Shared Infrastructure Services Object represents technical services used by an Input Device Object for functionality such as network addressing, network authentication, and software distribution.

21. A method as in claim 20 wherein, on the BTRM Dependency/Impact Hierarchy, the Shared Infrastructure Services Object is modeled below the Input Device Object.

22. A method as in claims 5 or 20 further including:
(a) The Shared Infrastructure Services Object Layer is considered a Bridged Common Object Layer.
(b) On the BTRM Dependency/Impact Hierarchy, the Shared Infrastructure Services Object Layer contains a discreet Dependency/Impact Hierarchy subset of Model Layers 8 through 13 and therefore, is dependent upon the subset layers within the Shared Infrastructure Services Object Layer.

23. A method as in claim 7, in which an Application Object represents software, operating system, program, and or data.

24. A method as in claim 23, further including:
(a) On the BTRM Dependency/Impact Hierarchy, the Application Object is modeled below the Input Device Object.
(b) On the BTRM Dependency/Impact Hierarchy, the Application Object is modeled above the Server Object.
(c) On the BTRM Dependency/Impact Hierarchy, the Application Object is dependent upon the Server Object.
(d) When the BTRM Dependency/Impact Hierarchy includes the abstraction of a Shared Data Storage Layer, the Application Object is also modeled above the Shared Data Storage Object.
(e) When the BTRM Dependency/Impact Hierarchy includes the abstraction of the Shared Data Storage Layer, the Application Object is also dependent upon the Shared Data Storage Object.

25. A method as in claims 7 or 23, further including:
(a) The BTRM Dependency/Impact Hierarchy considers files that contain commands as Program files, and those that do not as Data files.
(b) The BTRM Dependency/Impact Hierarchy considers Program files as a collection of commands that cause the computer to perform specific operations.
(c) The BTRM Dependency/Impact Hierarchy considers a Data file as a collection of information that can be structured, or unstructured.
(d) The BTRM Dependency/Impact Hierarchy considers that Data files are created, accessed, or manipulated by Program files.
(e) The BTRM Dependency/Impact Hierarchy considers that Data files do not cause the computer to perform operations.

26. A method as in claims 7 or 23, further include, within the BTRM Dependency/Impact Hierarchy Application Object Layer, there are four possible File Dependency/Impact Abstractions for Program and Data files.

27. A method as in claim 26, further including:
(a) When one Data file receives data from another Data file, the Data file receiving the data is modeled above and dependant upon the Data file from which the data originates.
(b) A Program file is modeled above a Data file when a Program file reads, writes, edits, deletes, or manipulates data in a Data file.
(c) A Data file is modeled above a Program file when a Program file reads, writes, edits, deletes, or manipulates a Data file.
(d) A Program file is modeled above another Program file when one Program file calls or launches another Program file.

28. A method as in claim 7, in which a Shared Data Storage Object represents a grouping of technical infrastructure objects.

29. A method as in claim 28 wherein, on the BTRM Dependency/Impact Hierarchy, the Shared Data Storage Object is modeled below the Application Object.

30. A method as in claims 5 or 28 further including:
(a) The Shared Data Storage Object Layer is considered a Bridged Common Object Layer.
(b) On the BTRM Dependency/Impact Hierarchy, the Shared Data Storage Object Layer contains a discreet Dependency/Impact Hierarchy subset of Model Layers 7 through 13 and therefore, is dependent upon the subset layers within the Shared Data Storage Object Layer.

31. A method as in claim 7, in which a Server Object represents an individual technical infrastructure component.

32. A method as in claim 31, further including:
(a) When the BTRM Dependency/Impact Hierarchy includes the abstraction of the Shared Data Storage Layer, the Server Object is modeled below the Shared Data Storage Object.
(b) When the BTRM Dependency/Impact Hierarchy does not include the abstraction of the Shared Data Storage Layer, the Server Object is modeled below the Application Object.
(c) On the BTRM Dependency/Impact Hierarchy, the Server Object is modeled above the Network Object.
(d) On the BTRM Dependency/Impact Hierarchy, the Server Object is dependent upon the Network Object.

33. A method as in claim 7, in which a Network Object represents an individual technical infrastructure component.

34. A method as in claim 33, further including:
(a) On the BTRM Dependency/Impact Hierarchy, the Network Object is modeled below the Server Object.
(b) On the BTRM Dependency/Impact Hierarchy, the Network Object is modeled above the Security Device Object.
(c) On the BTRM Dependency/Impact Hierarchy, the Network Object is dependent upon the Security Device Object.
(d) When the BTRM Dependency/Impact Hierarchy includes the abstraction of a Shared Network Object Layer, the Network Object is also modeled above the Shared Network Object.
(e) When the BTRM Dependency/Impact Hierarchy includes the abstraction of the Shared Network Object Layer, the Network Object is also dependent upon the Shared Network Object.

35. A method as in claim 7, in which a Shared Network Object represents a grouping of individual Network Objects.

36. A method as in claim 35 wherein, on the BTRM Dependency/Impact Hierarchy, the Shared Network Object is modeled below the Network Object.

37. A method as in claims 5 or 35 further including:
(a) The Shared Network Object Layer is considered a Bridged Common Object Layer.
(b) On the BTRM Dependency/Impact Hierarchy, the Shared Network Object Layer contains a discreet Dependency/Impact Hierarchy subset of Model Layers 11 through 13 and therefore, is dependent upon the subset layers within the Shared Network Object Layer.

38. A method as in claim 7, in which a Security Device Object represents an individual technical infrastructure component.

39. A method as in claim 38, further including:
(a) On the BTRM Dependency/Impact Hierarchy, the Security Device Object is modeled below the Network Object.
(b) The Security Device Object Layer is the lowest object in the 13 Layer BTRM Dependency/Impact Hierarchy Model and therefore has no defined dependencies.
